(19) United States
(12) Patent Application Publication
(10) Pub. No.: US 2021/0311478 A1
(43) Pub. Date: Oct. 7, 2021

(54) Systems and Methods For Autonomous Navigation To Locate User With Ultra-Wideband Sensing

(71) Applicant: Toyota Motor Engineering & Manufacturing North America, Inc., Plano, TX (US)

(72) Inventor: Jeffrey E. Pierfelice, Canton, MI (US)

(73) Assignee: Toyota Motor Engineering & Manufacturing North America, Inc., Plano, TX (US)

(21) Appl. No.: 16/841,819

(22) Filed: Apr. 7, 2020

(51) Int. Cl. G05D 1/02; G01C 21/36; G01C 21/34; B60Q 5/00; B60W 40/08; B60Q 9/00

(52) U.S. Cl. CPC G05D 1/0212; G05D 1/0231; G01C 21/3664; G01C 21/3407; G05D 2201/0213; B60W 40/08; B60Q 9/00; G05D 2201/0212; B60Q 5/005

(57) ABSTRACT

Systems and methods for autonomous navigation to locate a user via ultra-wideband (UWB) sensing include an autonomous vehicle and a navigation system configured to (i) interact, via a UWB sensor of the autonomous vehicle, with a smart mobile device of the user to locate the user for pick up at a pickup position by the autonomous vehicle; (ii) locate the user for pick up by the autonomous vehicle based on the UWB sensor interaction; (iii) navigate to and pick up the user at the pickup position via the autonomous vehicle; (iv) detect, via the UWB sensor, when the user is in the autonomous vehicle in a collected position; and (v) operate the autonomous vehicle when the user is detected via the UWB sensor to be in the autonomous vehicle in the collected position.

### TECHNICAL FIELD

The present specification generally relates to autonomous navigation and, more specifically, to systems and methods for autonomous navigation to locate a user with ultra-wideband (UWB) sensing.

### BACKGROUND

Autonomous vehicles may employ technology to utilize Global Positioning System (GPS) data to locate passengers. However, such GPS data may not be accurate enough to locate passengers with sufficient specificity. For instance, GPS data may not be able to differentiate which side of a street a user is on. For manually driven ridesharing vehicles, users may accommodate for inaccurate GPS data by verifying with the driver that they are the right passenger, calling the driver, and the like. However, such options to contact a manual driver are not typically available for autonomously operated ridesharing vehicles involving autonomous navigation. The user may desire a manner of an autonomous vehicle to accurately locate the user beyond use of GPS data to accommodate for potentially inaccurate GPS data.

### SUMMARY

In one embodiment, a navigation system may include one or more processors, a non-transitory memory communicatively coupled to the one or more processors, and machine readable instructions stored in the non-transitory memory. The machine readable instructions cause the navigation system to perform at least the following when executed by the one or more processors: interact, via an ultra-wideband (UWB) sensor of the autonomous vehicle, with a smart mobile device of a user to locate the user for pick up at a pickup position by the autonomous vehicle, locate the user for pick up by the autonomous vehicle based on the UWB sensor interaction, and navigate to and pick up the user at the pickup position via the autonomous vehicle. The machine readable instructions further cause the navigation system to perform at least the following when executed by the one or more processors: detect, via the UWB sensor, when the user is in the autonomous vehicle in a collected position, and operate the autonomous vehicle when the user is detected via the UWB sensor to be in the autonomous vehicle in the collected position.

In another embodiment, a method for autonomous navigation may include interacting, via an ultra-wideband (UWB) sensor of an autonomous vehicle, with a smart mobile device of a user to locate the user for pick up at a pickup position by the autonomous vehicle, locating the user for pick up by the autonomous vehicle based on the UWB sensor interaction, navigating to and pick up of the user at the pickup position via the autonomous vehicle, detecting, via the UWB sensor, when the user is in the autonomous vehicle in a collected position, and operating the autonomous vehicle when the user is detected via the UWB sensor to be in the autonomous vehicle in the collected position.

In one other embodiment, an autonomous vehicle may include a navigation system communicatively coupled to the autonomous vehicle, an ultra-wideband (UWB) sensor, one or more processors, a non-transitory memory communicatively coupled to the one or more processors, and machine readable instructions stored in the non-transitory memory. The machine readable instructions cause the autonomous vehicle to perform at least the following when executed by the one or more processors: interact, via a UWB sensor of the autonomous vehicle, with a smart mobile device of the user to locate the user for pick up at a pickup position by the autonomous vehicle, locate the user for pick up by the autonomous vehicle based on the UWB sensor interaction, and, via the navigation system, navigate to and pick up the user at the pickup position via the autonomous vehicle. The machine readable instructions further cause the autonomous vehicle to perform at least the following when executed by the one or more processors: detect, via the UWB sensor, when the user is in the autonomous vehicle in a collected position, and operate the autonomous vehicle when the user is detected via the UWB sensor to be in the autonomous vehicle in the collected position.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 schematically depicts an autonomous vehicle attempting to locate a user, according to one or more embodiments shown and described herein;

FIG. 2 schematically depicts a user in a collected position and seated in the autonomous vehicle of FIG. 1, according to one or more embodiments shown and described herein;

FIG. 3 schematically depicts a flowchart of a method for autonomous navigation to locate a user with ultra-wideband (UWB) sensing, according to one or more embodiments shown and described herein; and

FIG. 4 schematically depicts a system for implementing computer and software based methods for autonomous navigation to locate a user with UWB sensing, according to one or more embodiments shown and described herein.

### DETAILED DESCRIPTION

Embodiments of the present disclosure are directed to ridesharing technology for autonomous ridesharing vehicles to specifically locate passengers with use of ultra-wideband (UWB) via an autonomous ridesharing vehicle that is able to detect the location of a passenger with increased precision. Such an autonomous ridesharing vehicle equipped with UWB technology may be configured to interact with a smart mobile device of a user, for instance. The term “interact” or “interaction” as referenced herein describe an electronic communication including a transmission and reception of electronic data signals between at least two electronic devices, such as through wireless or wireless electronic communication networks. Through the use of UWB technology, the autonomous ridesharing vehicle may more accurately determine a user's location who requested the vehicle.

As a non-limiting example, the embodiments disclosed herein may be directed to locating users with ultra-wideband (UWB) sensing when a vehicle is in autonomous mode. Such UWB sensing utilizes UWB technology, such as UWB sensors, configured to implement radio technology via a pulse-based system that uses a low energy level for short-range, high-bandwidth communication over a broad portion of a radio spectrum, such as for transmission of information over a large bandwidth of greater than 500 MHz, as understood to one of ordinary skill in the art. Such UWB technology may employ transmit time communication schemes such as use of Time of Flight (ToF) to instead of signal strength measurement of electronic communications. The autonomous vehicles may, through a navigation system, locate a user with UWB sensing between the autonomous vehicle and the smart mobile device of the user, collect the user, determine the user is collected, and, based on the determination, navigate to deliver the collected user to a destination. Various autonomous navigation methods and systems will be described in more detail herein with specific reference to the corresponding drawings.

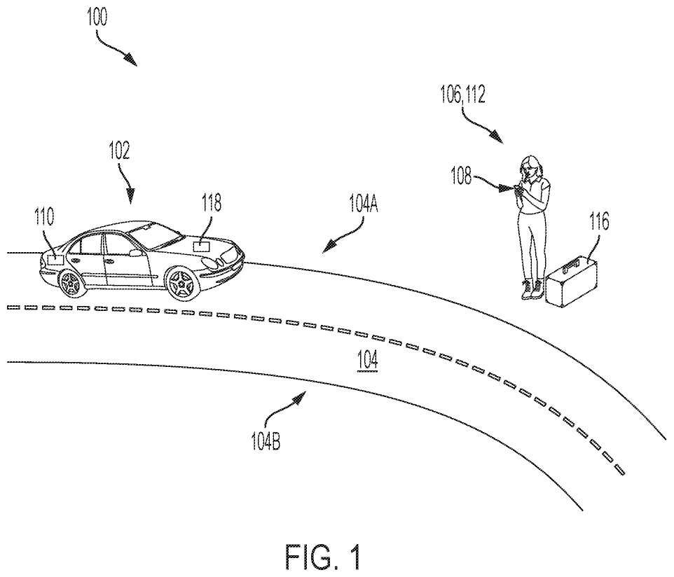

Referring to FIG. 1, an autonomous navigation solution 100 includes an autonomous vehicle 102 configured to drive on a roadway surface 104. A first side 104A is disposed on a first side of the roadway surface 104, and a second side 104B is disposed on a second side of the roadway surface 104 opposite the first side 104A. In the example, the roadway surface 104 is a street, the first side 104A is representative of a first side of the street such as a right side or a left side, and the second side 104B is representative of a second side of the street such as the other of the right side or the left side. In embodiments, the roadway surface 104 may be representative of an intersection, and the first side 104A or the second side 104B may be representative of one or more directional corners of the intersection. The one or more directional corners may include a north corner, a south corner, an east corner, a west corner, a north-east corner, a south-east corner, a north-west corner, a south-west corner, or combinations thereof.

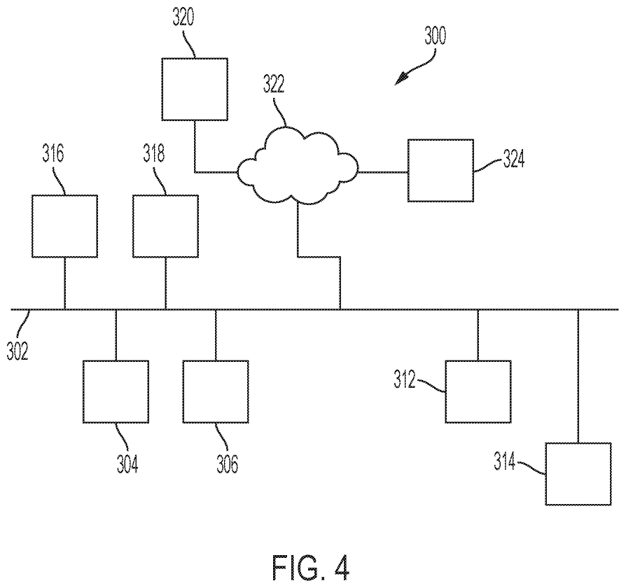

A user 106 may use a smart mobile device 108 to request pick up and a ride by the autonomous vehicle 102. The user 106 may request pick up at a pickup position 112. The autonomous vehicle 102 may use a UWB sensor 110 to interact with the smart mobile device 108 to locate the user 106 at the pickup position 112, as described in greater detail further below. In an embodiment, the autonomous vehicle 102, such as through a navigation system 300 described in greater detail below with respect to FIG. 4, is configured to determine the pickup position 112 is the first side 104A or the second side 104B of the roadway surface 104, and navigate to and pick up the user 106 at the pickup position 112 of the first side 104A or the second side 104B of the roadway surface 104 via the autonomous vehicle 102.

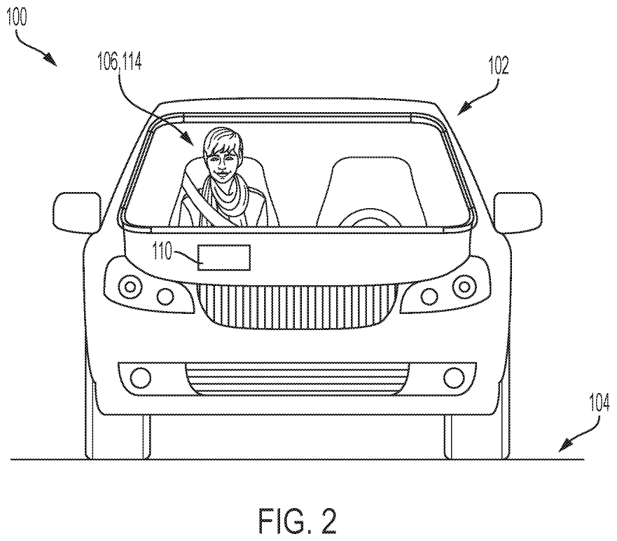

When the user 106 is picked up and seated in the autonomous vehicle 102, as shown in FIG. 2, the user 106 is in a collected position 114. The autonomous vehicle 102 may determine that the user is in the collected position 114 in the autonomous vehicle 102 prior to initiating vehicle operation to advance to a next destination. The next destination may be a destination provided by the user 106 or another pick up destination, such as for another pick up request at another pickup position 112 by another user 106. The autonomous vehicle 102, such as through the navigation system 300, may be configured to receive a request by the smart mobile device 108 of the user 106 for pick up at the pickup position 112, receive a destination from the smart mobile device 108 of the user 106 with the request, and navigate the autonomous vehicle 102 to the destination when the user 106 is detected in the collected position 114.

Referring again to FIG. 1, the user 106 may have a smart luggage 116 that may also interact with the UWB sensor 110. Furthermore, the autonomous vehicle 102 may include alert technology 118 to provide alert notifications to the user 106 via sound, tactile, and/or visual technologies. As a non-limiting example, the alert through the autonomous vehicle may include a sound alert, a haptic alert, a visual alert, or combinations thereof. Such alerts, as will be described in greater detail below, may include vehicle honking, vehicle lights flashing, and/or use of audio speakers to transmit an audio message to provide an indication to the user 106 of an event. The event may be, as a non-limiting example, that the smart mobile device 108 is sensed in the autonomous vehicle 102 but the user 106 is not sensed, thus generating a determination by the autonomous vehicle 102 that the user 106 has left the smart mobile device 108 in the autonomous vehicle. This determination may further be made after the destination requested by the user has been reached and, optionally, within a predetermined time frame of reaching the destination.

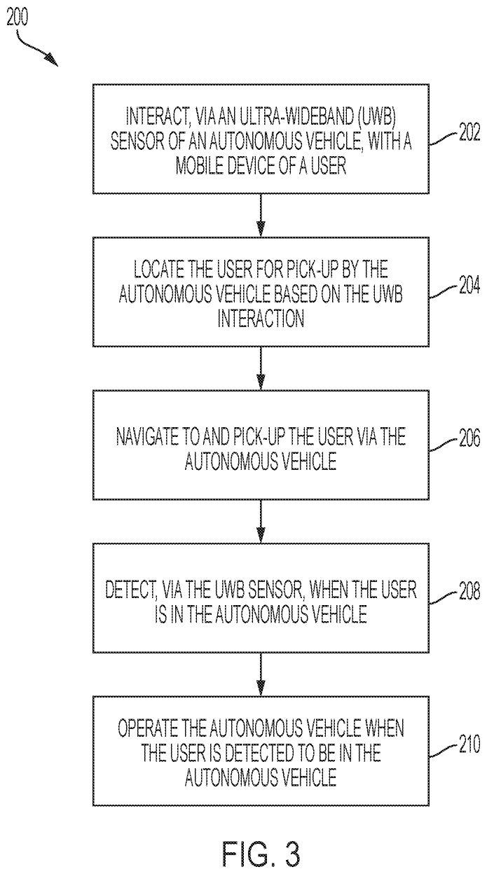

Referring to FIG. 3, a flowchart of a control scheme 200 of an autonomous navigation to locate a user 106 using UWB sensing is shown. In block 202, via the UWB sensor 110, the autonomous vehicle 102 interacts with the smart mobile device 108 of the user 106 for pick up at the pickup position 112 by the autonomous vehicle 102. In embodiments, a request by the smart mobile device 108 of the user 106 for pick up at the pickup position 112 is received by the autonomous vehicle 102. A destination may be received from the smart mobile device 108 of the user 106 with the request for pick up.

In block 204, the user 106 is located for pick up by the autonomous vehicle 102 based on the UWB sensor interaction of block 202. In an embodiment, based on the UWB sensor interaction, the pickup position 112 is determined to be the first side 104A or the second side 104B of the roadway surface 104.

In block 206, the autonomous vehicle 102 navigates to and picks up the user 106 at the pickup position 112. As a non-limiting example, the autonomous vehicle 102 navigates to and picks up the user 106 at the pickup position 112 that is determined to be the first side 104A or the second side 104B of the roadway surface 104. The autonomous vehicle 102 may be configured to detect via the interaction between the UWB sensor 110 and the smart mobile device 108 of the user 106 a distance to and a direction toward the user 106 to locate the user 106 with accuracy. Thus, the autonomous vehicle may determine how far away the user 106 is and on which side of the roadway surface 104 the user 106 is located.

In block 208, via the UWB sensor 110, the autonomous vehicle 102 detects when the user 106 is in the autonomous vehicle 102 in the collected position 114. Based on the interaction between the UWB sensor 110 and the smart mobile device 108 of the user 106 to determine the distance to and the direction toward the user 106, the autonomous vehicle 102 may determine when the user 106 is in the collected position 114 and seated in the autonomous vehicle 102. The autonomous vehicle 102 may further be configured to use other vehicle sensors to determine when the user 106 is in the collected position 114. By way of example, and not as a limitation, the autonomous vehicle 102 may include a knowledge database comprising one or more internal vehicle characteristics, such as, but not limited to, cabin space dimensions, rear seat distance dimensions, other internal spacing dimensions, and the like to determine when the user 106 is in vehicle. Other vehicle sensors in vehicle may further be utilized (e.g., seat sensors and/or cameras inside the vehicle) to assist with a confidence value of the determination that the user 106 is in the autonomous vehicle 102. The autonomous vehicle 102 may be configured to determine the confidence value and/or a probability calculation based on the UWB sensor 110 interaction with the smart mobile device, use of the knowledge database of one or more internal vehicle characteristics, other vehicle sensors in the autonomous vehicle 102, or combinations thereof. The confidence value may be representative of a determined confidence associated with a determination that the user 106 is in the collected position 114, and the probability calculation may be representative of a probability that the user 106 is in the collected position 114 associated with the determination by the autonomous vehicle 102. In embodiments, when the confidence value and/or the probability calculation is above a threshold, the autonomous vehicle 102 may then provide the determination that the user 106 is in the collected position 114.

Based on a determination that the user 106 is in the collected position 114, the autonomous vehicle 102 can start navigating to the next destination. Prior to navigation, the autonomous vehicle may request feedback from the user 106, such as requesting the user 106 to confirm the user 106 is in the autonomous vehicle 102. Such feedback may be requested through the smart mobile device 108 of the user 106, through a display within the autonomous vehicle 102, through audio technology within the autonomous vehicle 102, or combinations thereof. The feedback may be requested during multiple stages and when the user 106 has reached the destination requested by the user 106. For instance, the autonomous vehicle 102 may request the user 106 to confirm that the user 106 has reached the destination requested by the user.

In block 210, the autonomous vehicle 102 begins operation, such as to start navigation, when the user 106 is detected via the UWB sensor 110 to be in the autonomous vehicle 102 in the collected position 114. The autonomous vehicle 102 may delay operation for a predetermined time period to provide the user 106 with sufficient time to be seated prior to vehicle operation, may request user feedback that the user 106 is in the collected position such as through the smart mobile device 108 or a feedback console within the autonomous vehicle, or combinations thereof. The autonomous vehicle 102 may then navigate to the destination received when the user 106 is detected in the collected position 114. In an embodiment in which multiple passengers are riding in the autonomous vehicle 102, the application tool utilized by the smart mobile device 108 to interact with the autonomous vehicle 102 may need to be informed about the multiple passengers.

When the user 106 reaches the destination requested by the user 106, the autonomous vehicle 102 may determine that the smart mobile device 108 remains within the autonomous vehicle 102 while the user 106 has left the autonomous vehicle 102. The autonomous vehicle 102 may make such a determination through a combination of interaction between the UWB sensor 110 and the smart mobile device 108 as well as use of vehicle sensors as described herein to determine the user 106 is not within the autonomous vehicle 102. In an embodiment, the autonomous vehicle 102, such as through the navigation system 300, is configured to navigate to a destination when the user 106 is detected in the collected position 114, determine as a user exit determination that the user 106 has exited the autonomous vehicle 102 based on one or more vehicle sensors, determine as a device determination that the smart mobile device 108 is within the autonomous vehicle 102 based on the interaction between the UWB sensor 110 and the smart mobile device 108, and alert the user that the smart mobile device 108 is within the autonomous vehicle 102 via an alert notification based on the user exit determination and the device determination.

In embodiments, the UWB sensor 110 of the autonomous vehicle 102 may interact with the smart luggage 116 of the user 106 to sense whether, after the user 106 and the smart mobile device 108 has left the autonomous vehicle 102, the user 106 has collected the smart luggage 116 from, for example, a trunk of the autonomous vehicle 102 within a predetermined period of time. The autonomous vehicle 102 may sense whether the smart luggage has been collected from the trunk based on internal truck characteristics in the knowledge database, knowledge of whether the trunk is open or closed via associated vehicle sensors such as trunk sensors, or combinations thereof. If the autonomous vehicle 102 detects that the smart luggage 116 has not been collected, such as after the predetermined period of time, the autonomous vehicle 102 may alert the user 106 through the alert technology 118, a notification message to the application tool of the smart mobile device 108, or combinations thereof and as described herein. The autonomous vehicle 102, such as through the navigation system 300, may be configured to navigate to a destination when the user 106 is detected in the collected position 114, determine as the user exit determination that the user 106 has exited the autonomous vehicle 102 based on one or more vehicle sensors, determine as a luggage determination that the smart luggage 116 of the user 106 is within the autonomous vehicle 102 based on the interaction between the UWB sensor 110 and the smart luggage 116, and alert the user 106 that the smart luggage 116 is within the autonomous vehicle 102 via an alert notification based on the user exit determination and the luggage determination.

The alert notifications described herein may include an alert through the alert technology 118 associated with the autonomous vehicle 102, a notification message transmitted to an application tool of the smart mobile device 108, or combinations thereof. In embodiments, the alert technology 118 includes sound technology, tactile technology, visual technology, or combinations thereof. The alert technology 118 may be configured to generate the alert through the autonomous vehicle 102 that includes a sound alert, a haptic alert, a visual alert, or combinations thereof. The visual alert may include one or more vehicle lights flashing, and the sound alert may include vehicle honking, an audio message transmitted by audio speakers, or combinations thereof.

The autonomous vehicle 102 and the navigation system 300 may thus be configured to (1) interact, via the UWB sensor 110, with a smart mobile device 108 of a user 106 in a pickup position 112 to locate the user 106 for pick up at the pickup position 112 by the autonomous vehicle 102 (FIG. 1), (2) detect, via the UWB sensor 110, when the user 106 is in the autonomous vehicle in a collected position 114 (FIG. 2), and (3) operate the autonomous vehicle 102 when the user 106 is detected via the UWB sensor 110 to be in the autonomous vehicle 102 to navigate the autonomous vehicle 102 to a destination.

Referring to FIG. 4, the navigation system 300 for implementing a computer and software-based method to utilize the system devices to autonomously navigate an autonomous vehicle 102 to locate a user 106 via UWB sensing is illustrated. The navigation system 300 may be implemented along with using a graphical user interface (GUI) that is accessible at a computing device (e.g., a computer 324), for example. The computing device may be a smart mobile device 108, which may be a smartphone, a tablet, or a like portable handheld smart device. As a non-limiting example, the smart mobile device 108 may be a smartphone or a tablet. The machine readable instructions may cause the navigation system 300 to, when executed by the processor, interact with a software application tool on the smart mobile device 108 of the user 106. The machine readable instructions may cause the navigation system 300 to, when executed by the processor, interact with the software application tool to follow one or more control schemes as set forth in the one or more processes described herein.

The navigation system 300 includes machine readable instructions stored in non-transitory memory that cause the navigation system 300 to perform one or more of instructions when executed by the one or more processors, as described in greater detail below. The navigation system 300 includes a communication path 302, one or more processors 304, a memory component 306, a localization component 312, a storage or database 314 that may include a product image database, an alert component 316, a network interface hardware 318, a server 320, a network 322, and at least one computer 324. The various components of the navigation system 300 and the interaction thereof will be described in detail below.

In some embodiments, the navigation system 300 is implemented using a wide area network (WAN) or network 322, such as an intranet or the Internet, or other wired or wireless communication network that may include a cloud computing-based network configuration. The computer 324 may include digital systems and other devices permitting connection to and navigation of the network, such as the smart mobile device. Other navigation system 300 variations allowing for communication between various geographically diverse components are possible. The lines depicted in FIG. 4 indicate communication rather than physical connections between the various components.

As noted above, the navigation system 300 includes the communication path 302. The communication path 302 may be formed from any medium that is capable of transmitting a signal such as, for example, conductive wires, conductive traces, optical waveguides, or the like, or from a combination of mediums capable of transmitting signals. The communication path 302 communicatively couples the various components of the navigation system 300. As used herein, the term “communicatively coupled” means that coupled components are capable of exchanging data signals with one another such as, for example, electrical signals via conductive medium, electromagnetic signals via air, optical signals via optical waveguides, and the like.

As noted above, the navigation system 300 includes the processor 304. The processor 304 can be any device capable of executing machine readable instructions. Accordingly, the processor 304 may be a controller, an integrated circuit, a microchip, a computer, or any other computing device. The processor 304 is communicatively coupled to the other components of the navigation system 300 by the communication path 302. Accordingly, the communication path 302 may communicatively couple any number of processors with one another, and allow the modules coupled to the communication path 302 to operate in a distributed computing environment. Specifically, each of the modules can operate as a node that may send and/or receive data. The processor 304 may process the input signals received from the system modules and/or extract information from such signals.

As noted above, the navigation system 300 includes the memory component 306 which is coupled to the communication path 302 and communicatively coupled to the processor 304. The memory component 306 may be a non-transitory computer readable medium or non-transitory computer readable memory and may be configured as a nonvolatile computer readable medium. The memory component 306 may comprise RAM, ROM, flash memories, hard drives, or any device capable of storing machine readable instructions such that the machine readable instructions can be accessed and executed by the processor 304. The machine readable instructions may comprise logic or algorithm(s) written in any programming language such as, for example, machine language that may be directly executed by the processor, or assembly language, object-oriented programming (OOP), scripting languages, microcode, etc., that may be compiled or assembled into machine readable instructions and stored on the memory component 306. Alternatively, the machine readable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components. In embodiments, the navigation system 300 may include the processor 304 communicatively coupled to the memory component 306 that stores instructions that, when executed by the processor 304, cause the processor to perform one or more functions as described herein.

Still referring to FIG. 4, as noted above, the navigation system 300 may comprise the display such as a GUI on a screen of the computer 324 for providing visual output such as, for example, information, graphical reports, messages, or a combination thereof. The computer 324 may include one or more computing devices across platforms, or may be communicatively coupled to devices across platforms, such as smart mobile devices including smartphones, tablets, laptops, and/or the like. The display on the screen of the computer 324 is coupled to the communication path 302 and communicatively coupled to the processor 304. Accordingly, the communication path 302 communicatively couples the display to other modules of the navigation system 300. The display can include any medium capable of transmitting an optical output such as, for example, a cathode ray tube, light emitting diodes, a liquid crystal display, a plasma display, or the like. Additionally, it is noted that the display or the computer 324 can include at least one of the processor 304 and the memory component 306. While the navigation system 300 is illustrated as a single, integrated system in FIG. 4, in other embodiments, the systems can be independent systems.

The navigation system 300 may comprises: (i) the localization component 312 of the autonomous vehicle 102 to locate a user 106 via UWB sensing between a smart mobile device 108 of the user 106 and a UWB sensor 110 of the autonomous vehicle 102 and (ii) the alert component 316 to alert a user to an event, such as a determination that the smart mobile device 108 and/or the smart luggage 116 remains in the autonomous vehicle 102 when the user 106 is determined to not be within the autonomous vehicle 102 as described herein. Further, an artificial intelligence component may be used in embodiments to train and provide machine learning capabilities to a neural network to aid with improvement of confidence of a determination the user 106 is seated in the autonomous vehicle 102 as described herein. The localization component 312 and the alert component 316 are coupled to the communication path 302 and communicatively coupled to the processor 304. The processor 304 may process the input signals received from the system modules and/or extract information from such signals.

Data stored and manipulated in the navigation system 300 as described herein is utilized by the artificial intelligence component, which is able to leverage a cloud computing-based network configuration such as the cloud to apply Machine Learning and Artificial Intelligence. This machine learning application may create models that can be applied by the navigation system 300, to make it more efficient and intelligent in execution. As an example and not a limitation, the artificial intelligence component may include components selected from the group consisting of an artificial intelligence engine, Bayesian inference engine, and a decision-making engine, and may have an adaptive learning engine further comprising a deep neural network learning engine.

The navigation system 300 includes the network interface hardware 318 for communicatively coupling the navigation system 300 with a computer network such as network 322. The network interface hardware 318 is coupled to the communication path 302 such that the communication path 302 communicatively couples the network interface hardware 218 to other modules of the navigation system 300. The network interface hardware 318 can be any device capable of transmitting and/or receiving data via a wireless network. Accordingly, the network interface hardware 318 can include a communication transceiver for sending and/or receiving data according to any wireless communication standard. For example, the network interface hardware 318 can include a chipset (e.g., antenna, processors, machine readable instructions, etc.) to communicate over wired and/or wireless computer networks such as, for example, wireless fidelity (Wi-Fi), WiMax, Bluetooth, IrDA, Wireless USB, Z-Wave, ZigBee, or the like.

Still referring to FIG. 4, data from various applications running on computer 324 can be provided from the computer 324 to the navigation system 300 via the network interface hardware 318. The computer 324 can be any device having hardware (e.g., chipsets, processors, memory, etc.) for communicatively coupling with the network interface hardware 318 and a network 322. Specifically, the computer 324 can include an input device having an antenna for communicating over one or more of the wireless computer networks described above.

The network 322 can include any wired and/or wireless network such as, for example, wide area networks, metropolitan area networks, the Internet, an Intranet, the cloud 323, satellite networks, or the like. Accordingly, the network 322 can be utilized as a wireless access point by the computer 324 to access one or more servers (e.g., a server 320). The server 320 and any additional servers such as a cloud server generally include processors, memory, and chipset for delivering resources via the network 322. Resources can include providing, for example, processing, storage, software, and information from the server 320 to the navigation system 300 via the network 322. Additionally, it is noted that the server 320 and any additional servers can share resources with one another over the network 322 such as, for example, via the wired portion of the network, the wireless portion of the network, or combinations thereof.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A navigation system of an autonomous vehicle, the navigation system comprising:
one or more processors;
a non-transitory memory communicatively coupled to the one or more processors; and
machine readable instructions stored in the non-transitory memory that cause the navigation system to perform at least the following when executed by the one or more processors:
interact, via an ultra-wideband (UWB) sensor of the autonomous vehicle, with a smart mobile device of a user to locate the user for pick up at a pickup position by the autonomous vehicle;
locate the user for pick up by the autonomous vehicle based on the UWB sensor interaction;
navigate to and pick up the user at the pickup position via the autonomous vehicle;
detect, via the UWB sensor, when the user is in the autonomous vehicle in a collected position; and
operate the autonomous vehicle when the user is detected via the UWB sensor to be in the autonomous vehicle in the collected position.

2. The navigation system of claim 1, further comprising machine readable instructions that cause the navigation system to perform at least the following when executed by the one or more processors:
receive a request by the smart mobile device of the user for pick up at the pickup position;
receive a destination from the smart mobile device of the user with the request; and
navigate the autonomous vehicle to the destination when the user is detected in the collected position.

3. The navigation system of claim 1, further comprising machine readable instructions that cause the navigation system to perform at least the following when executed by the one or more processors:
determine the pickup position is a first side or a second side of a roadway surface; and
navigate to and pick up the user at the pickup position of the first side or the second side of the roadway surface via the autonomous vehicle.

4. The navigation system of claim 1, wherein the machine readable instructions further cause the navigation system to perform at least the following when executed by the one or more processors:
navigate the autonomous vehicle to a destination when the user is detected in the collected position;
determine as a user exit determination that the user has exited the autonomous vehicle based on one or more vehicle sensors;
determine as a device determination that the smart mobile device is within the autonomous vehicle based on the interaction between the UWB sensor and the smart mobile device; and
alert the user that the smart mobile device is within the autonomous vehicle via an alert notification based on the user exit determination and the device determination.

5. The navigation system of claim 4, wherein the alert notification comprises an alert through the autonomous vehicle, a notification message transmitted to an application tool of the smart mobile device, or combinations thereof.

6. The navigation system of claim 5, wherein the alert through the autonomous vehicle comprises a sound alert, a haptic alert, a visual alert, or combinations thereof.

7. The navigation system of claim 6, wherein the visual alert comprises one or more vehicle lights flashing and the sound alert comprises vehicle honking, an audio message transmitted by audio speakers, or combinations thereof.

8. The navigation system of claim 1, wherein the machine readable instructions further cause the navigation system to perform at least the following when executed by the one or more processors:
navigate the autonomous vehicle to a destination when the user is detected in the collected position;
determine as a user exit determination that the user has exited the autonomous vehicle based on one or more vehicle sensors;
determine as a luggage determination that a smart luggage of the user is within the autonomous vehicle based on the interaction between the UWB sensor and the smart luggage; and
alert the user that the smart luggage is within the autonomous vehicle via an alert notification based on the user exit determination and the luggage determination.

9. A method for autonomous navigation, the method comprising:
interacting, via an ultra-wideband (UWB) sensor of an autonomous vehicle, with a smart mobile device of a user to locate the user for pick up at a pickup position by the autonomous vehicle;
locating the user for pick up by the autonomous vehicle based on the UWB sensor interaction;
navigating to and pick up of the user at the pickup position via the autonomous vehicle;
detecting, via the UWB sensor, when the user is in the autonomous vehicle in a collected position; and
operating the autonomous vehicle when the user is detected via the UWB sensor to be in the autonomous vehicle in the collected position.

10. The method of claim 9, further comprising:
receiving a request by the smart mobile device of the user for pick up at the pickup position;
receiving a destination from the smart mobile device of the user with the request; and
navigating the autonomous vehicle to the destination when the user is detected in the collected position.

11. The method of claim 9, further comprising:
determining the pickup position is a first side or a second side of a roadway surface; and
navigating to and picking up the user at the pickup position of the first side or the second side of the roadway surface via the autonomous vehicle.

12. The method of claim 9, further comprising:
navigating the autonomous vehicle to a destination when the user is detected in the collected position;
determining as a user exit determination that the user has exited the autonomous vehicle based on one or more vehicle sensors;
determining as a device determination that the smart mobile device is within the autonomous vehicle based on the interaction between the UWB sensor and the smart mobile device; and
alerting the user that the smart mobile device is within the autonomous vehicle via an alert notification based on the user exit determination and the device determination.

13. The method of claim 12, wherein the alert notification comprises an alert through an alert technology associated with the autonomous vehicle, a notification message transmitted to an application tool of the smart mobile device, or combinations thereof.

14. The method of claim 13, wherein the alert through the autonomous vehicle comprises a sound alert, a haptic alert, a visual alert, or combinations thereof.

15. The method of claim 14, wherein the visual alert comprises one or more vehicle lights flashing and the sound alert comprises vehicle honking, an audio message transmitted by audio speakers, or combinations thereof.

16. The method of claim 9, further comprising:
navigating the autonomous vehicle to a destination when the user is detected in the collected position;
determining as a user exit determination that the user has exited the autonomous vehicle based on one or more vehicle sensors;
determining as a luggage determination that a smart luggage of the user is within the autonomous vehicle based on the interaction between the UWB sensor and the smart luggage; and
alerting the user that the smart luggage is within the autonomous vehicle via an alert notification based on the user exit determination and the luggage determination.

17. An autonomous vehicle comprising:
a navigation system communicatively coupled to the autonomous vehicle;
an ultra-wideband (UWB) sensor;
one or more processors;
a non-transitory memory communicatively coupled to the one or more processors; and
machine readable instructions stored in the non-transitory memory that cause the autonomous vehicle to perform at least the following when executed by the one or more processors:
interact, via a UWB sensor of the autonomous vehicle, with a smart mobile device of a user to locate the user for pick up at a pickup position by the autonomous vehicle;
locate the user for pick up by the autonomous vehicle based on the UWB sensor interaction;
via the navigation system, navigate to and pick up the user at the pickup position via the autonomous vehicle;
detect, via the UWB sensor, when the user is in the autonomous vehicle in a collected position; and
operate the autonomous vehicle when the user is detected via the UWB sensor to be in the autonomous vehicle in the collected position.

18. The autonomous vehicle of claim 17, wherein the machine readable instructions further cause the autonomous vehicle to perform at least the following when executed by the one or more processors:
receive a request by the smart mobile device of the user for pick up at the pickup position;
receive a destination from the smart mobile device of the user with the request; and
navigate the autonomous vehicle to the destination when the user is detected in the collected position.

19. The autonomous vehicle of claim 17, wherein the machine readable instructions further cause the autonomous vehicle to perform at least the following when executed by the one or more processors:
navigate to a destination when the user is detected in the collected position;
determine as a user exit determination that the user has exited the autonomous vehicle based on one or more vehicle sensors;
determine as a device determination that the smart mobile device is within the autonomous vehicle based on the interaction between the UWB sensor and the smart mobile device; and
alert the user that the smart mobile device is within the autonomous vehicle via an alert notification based on the user exit determination and the device determination.

20. The autonomous vehicle of claim 17, wherein the machine readable instructions further cause the autonomous vehicle to perform at least the following when executed by the one or more processors:
navigate to a destination when the user is detected in the collected position;
determine as a user exit determination that the user has exited the autonomous vehicle based on one or more vehicle sensors;
determine as a luggage determination that a smart luggage of the user is within the autonomous vehicle based on the interaction between the UWB sensor and the smart luggage; and
alert the user that the smart luggage is within the autonomous vehicle via an alert notification based on the user exit determination and the luggage determination.
